(19) United States
(12) Patent Application Publication
(10) Pub. No.: US 2025/0034487 A1
(43) Pub. Date: Jan. 30, 2025

(54) FABRIC CARE COMPOSITION

(71) Applicant: Rohm and Haas Company, Collegeville, PA (US)

(72) Inventors: Daniel S. Miller, Phoenixville, PA (US); Lyndsay M. Leal, Spring City, PA (US); Benjamin Reiner, Collegeville, PA (US); Michelle Gallagher, Cherry Hill, NJ (US); Randara Pulukkody, Lansdale, PA (US)

(21) Appl. No.: 18/847,698

(22) PCT Filed: Mar. 20, 2023
(86) PCT No.: PCT/US2023/015624

§ 371 Date: Sep. 17, 2024

Related U.S. Application Data
(60) Provisional application No. 63/322,239, filed on Mar. 22, 2022.

(51) Int. Cl. C11D 3/22; C11D 1/22; C11D 1/29; C11D 1/72; C11D 1/83; C11D 3/50

(52) U.S. Cl. CPC C11D 3/227; C11D 1/22; C11D 1/29; C11D 1/721; C11D 1/83; C11D 3/50; C11D 2111/12

(57) ABSTRACT

A fabric care composition is provided, comprising: water; fragrance; and deposition aid polymer, comprising dextran base polymer functionalized with quaternary ammonium groups; wherein quaternary ammonium groups include a quaternary ammonium group of formula (II) bound to a pendent oxygen on the dextran base polymer and a quaternary ammonium group of formula (III) (II) (III); wherein is pendent oxygen on dextran base polymer; wherein X is a divalent linking group; wherein R2 is selected from C1-4 alkyl group; wherein R3 is selected from C1-4 alkyl group; and wherein R4 is selected from linear or branched C8-20 alkyl group; wherein degree of substitution, DS(II), of formula (II) on deposition aid polymer is 0.01 to 0.245; wherein degree of substitution, DS(III), of formula (III) on deposition aid polymer is >0 to 0.05; and wherein deposition aid polymer enhances deposition of fragrance onto fabric relative to otherwise identical formulation without deposition aid polymer.

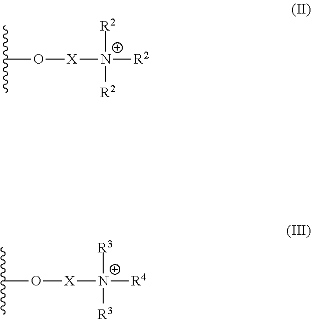

The present invention relates to a fabric care composition. In particular, the present invention relates to a fabric care composition including water; a cleaning surfactant; a fragrance; and a deposition aid polymer, wherein the deposition aid polymer is a cationic dextran polymer, comprising a dextran base polymer functionalized with quaternary ammonium groups; wherein the dextran base polymer has a weight average molecular weight of 50,000 to 3,000,000 Daltons; wherein the quaternary ammonium groups include (i) a quaternary ammonium group of formula (II) bound to a pendent oxygen on the dextran base polymer and (ii) a quaternary ammonium group of formula (III) bound to a pendent oxygen on the dextran base polymer

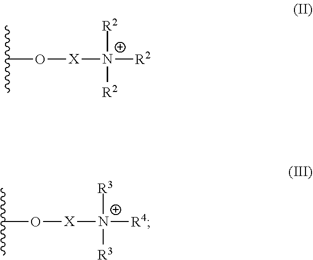

wherein

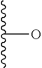 [SMILES: *O]

is a pendent oxygen on the dextran base polymer; wherein X is a divalent linking group; wherein each R² is independently selected from a C₁₋₄ alkyl group; wherein each R³ is independently selected from a C₁₋₄ alkyl group; and wherein each R⁴ is independently selected from a linear or branched C₈₋₂₀ alkyl group; wherein the degree of substitution, DS_{(II)}, of quaternary ammonium groups of formula (II) on the cationic dextran polymer is 0.01 to 0.245; wherein the degree of substitution, DS_{(III)}, of quaternary ammonium groups of formula (III) on the cationic dextran polymer is >0 to 0.05; wherein the deposition aid polymer enhances deposition of the fragrance from the fabric care composition onto a fabric relative to an otherwise identical formulation without the deposition aid polymer.

Use of cationic carbohydrate polymers in laundry detergents is known, as in, e.g., U.S. Pat. No. 6,833,347. However, this reference does not suggest the use of the modified polymers described herein.

A modified carbohydrate polymer having quaternary ammonium groups has been disclosed for use in fabric care by Eldredge, et al. in U.S. Patent Application Publication No. 20170335242. Eldredge, et al disclose a fabric care composition comprising a modified carbohydrate polymer having quaternary ammonium groups having at least one C₈₋₂₂ alkyl or alkenyl group; wherein the modified carbohydrate polymer has a weight average molecular weight of at least 500,000; and wherein at least 20 wt % of the quaternary ammonium groups on the at least one modified carbohydrate polymer have at least one C₈₋₂₂ alkyl or alkenyl group.

Notwithstanding, there remains a continuing need for fabric care compositions having a desirable balance of performance properties, particularly fragrance deposition.

The present invention provides a fabric care composition, comprising: water; a fragrance; and a deposition aid polymer, wherein the deposition aid polymer is a cationic dextran polymer, comprising a dextran base polymer functionalized with quaternary ammonium groups; wherein the dextran base polymer has a weight average molecular weight of 50,000 to 3,000,000 Daltons; wherein the quaternary ammonium groups include (i) a quaternary ammonium group of formula (11) bound to a pendent oxygen on the dextran base polymer and (ii) a quaternary ammonium group of formula (III) bound to a pendent oxygen on the dextran base polymer

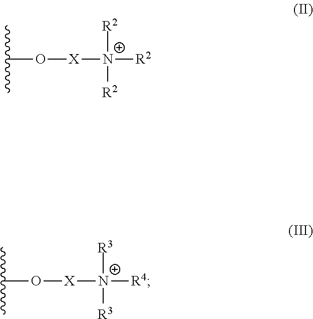

wherein

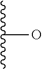 [SMILES: *O]

is a pendent oxygen on the dextran base polymer; wherein X is a divalent linking group; wherein each R² is independently selected from a C₁₋₄ alkyl group; wherein each R³ is independently selected from a C₁₋₄ alkyl group; and wherein each R⁴ is independently selected from a linear or branched C₈₋₂₀ alkyl group; wherein the degree of substitution, DS_{(II)}, of quaternary ammonium groups of formula (II) on the cationic dextran polymer is 0.01 to 0.245; wherein the degree of substitution, DS_{(III)}, of quaternary ammonium groups of formula (III) on the cationic dextran polymer is >0 to 0.05; wherein the deposition aid polymer enhances deposition of the fragrance from the fabric care composition onto a fabric relative to an otherwise identical formulation without the deposition aid polymer.

The present invention provides a method of treating an article of laundry, comprising: providing an article of laundry; selecting a fabric care composition according to the present invention; providing a bath water; and applying the bath water and the fabric care composition to the article of laundry to provide a treated article of laundry; wherein the fragrance is associated with the treated article of laundry.

### DETAILED DESCRIPTION

It has been found that a fabric care composition including a fragrance in combination with a deposition aid polymer, wherein the deposition aid polymer is a cationic dextran polymer, comprising a dextran base polymer functionalized with quaternary ammonium groups; wherein the dextran base polymer has a weight average molecular weight of 50,000 to 3,000,000 Daltons; wherein the quaternary ammonium groups include (i) a quaternary ammonium group of formula (11) bound to a pendent oxygen on the dextran base polymer and (ii) a quaternary ammonium group of formula (III) bound to a pendent oxygen on the dextran base polymer

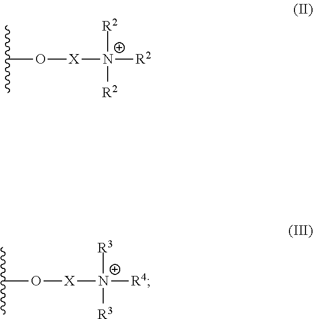

wherein

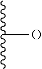 [SMILES: *O]

is a pendent oxygen on the dextran base polymer; wherein X is a divalent linking group; wherein each R² is independently selected from a C₁₋₄ alkyl group; wherein each R³ is independently selected from a C₁₋₄ alkyl group; and wherein each R⁴ is independently selected from a linear or branched C₈₋₂₀ alkyl group; wherein the degree of substitution, DS_{(II)}, of quaternary ammonium groups of formula (II) on the cationic dextran polymer is 0.01 to 0.245; and wherein the degree of substitution, DS, of quaternary ammonium groups of formula (III) on the cationic dextran polymer is >0 to 0.05; provides a surprisingly favorable balance of performance properties including enhanced deposition of fragrance onto fabric relative to an otherwise identical formulation without the deposition aid polymer (preferably, wherein the viscosity of the fabric care composition is not significantly thickened by incorporation of the deposition aid polymer (i.e., <30% increase (more preferably, <20% increase) in viscosity of the fabric care composition upon addition of the deposition aid polymer)(preferably, wherein the favorable balance of performance properties includes soil anti-redeposition).

Unless otherwise indicated, ratios, percentages, parts, and the like are by weight. Weight percentages (or wt %) in the composition are percentages of dry weight, i.e., excluding any water that may be present in the composition.

As used herein, unless otherwise indicated, the terms “weight average molecular weight” and “Mw” are used interchangeably to refer to the weight average molecular weight as measured in a conventional manner with gel permeation chromatography (GPC) and conventional standards, such as polyethylene glycol standards. GPC techniques are discussed in detail in Modem Size Exclusion Chromatography, W. W. Yau, J. J. Kirkland, D. D. Bly; Wiley-lnterscience, 1979, and in A Guide to Materials Characterization and Chemical Analysis, J. P. Sibilia; VCH, 1988, p. 81-84. Weight average molecular weights are reported herein in units of Daltons.

Preferably, the fabric care composition of the present invention, comprises: water (preferably, 10 to 99.98 wt % (preferably, 20 to 94.9 wt %; more preferably, 35 to 89.8 wt %; most preferably, 50 to 84 wt %), based on weight of the fabric care composition, of water); optionally, a cleaning surfactant (preferably, 0 to 89.9 wt % (preferably, 5 to 75 wt %; more preferably, 10 to 60 wt %; most preferably, 15 to 40 wt %), based on weight of the fabric care composition, of a cleaning surfactant); a fragrance (preferably, 0.01 to 3 wt % (preferably, 0.05 to 2.5 wt %; more preferably, 0.1 to 2 wt %; most preferably, 0.5 to 1.5 wt %), based on weight of the fabric care composition, of a fragrance); and a deposition aid polymer (preferably, 0.01 to 5 wt % (preferably, 0.05 to 4 wt %; more preferably, 0.1 to 3 wt %; most preferably, 0.5 to 2 wt %), based on weight of the fabric care composition, of a deposition aid polymer), wherein the deposition aid polymer is a cationic dextran polymer, comprising a dextran base polymer functionalized with quaternary ammonium groups; wherein the dextran base polymer has a weight average molecular weight of 50,000 to 3,000,000 Daltons; wherein the quaternary ammonium groups include (i) a quaternary ammonium group of formula (II) bound to a pendent oxygen on the dextran base polymer and (ii) a quaternary ammonium group of formula (III) bound to a pendent oxygen on the dextran base polymer

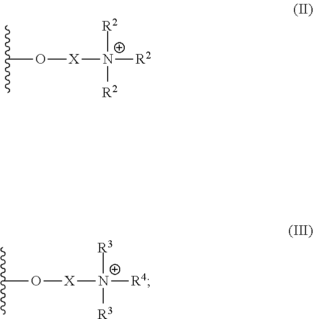

wherein

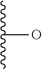 [SMILES: *O]

is a pendent oxygen on the dextran base polymer; wherein X is a divalent linking group; wherein each R² is independently selected from a C₁₋₄ alkyl group; wherein each R³ is independently selected from a C₁₋₄ alkyl group; and wherein each R⁴ is independently selected from a linear or branched C₈₋₂₀ alkyl group (preferably, a linear or branched C₁₀₋₁₆ alkyl group; more preferably, a linear or branched C₁₀₋₁₄ alkyl group; still more preferably, a linear or branched C₁₂ alkyl group; most preferably, a linear C₁₂ alkyl group); wherein the degree of substitution, DS_{(II)}, of quaternary ammonium groups of formula (II) on the cationic dextran polymer is 0.01 to 0.245 (preferably, 0.1 to 0.2); wherein the degree of substitution, DS_{(III)}, of quaternary ammonium groups of formula (III) on the cationic dextran polymer is >0 to 0.05 (preferably, 0.003 to 0.05; more preferably, 0.005 to 0.02; most preferably, >0.007 to 0.01); and wherein the deposition aid polymer enhances deposition of the fragrance from the fabric care composition onto a fabric relative to an otherwise identical formulation without the deposition aid polymer (preferably, wherein the fabric is selected from the group consisting of cotton interlock, cotton, poly cotton blend and cotton terry; more preferably, wherein the fabric contains cotton; most preferably, wherein the fabric is cotton).

Preferably, the fabric care composition of the present invention is a liquid formulation. More preferably, the fabric care composition of the present invention is an aqueous liquid formulation. Most preferably, the fabric care composition of the present invention is an aqueous liquid laundry detergent formulation.

Preferably, the fabric care composition of the present invention, comprises 10 to 94.98 wt % (preferably, 20 to 92.4 wt %; more preferably, 35 to 89.8 wt %; most preferably, 50 to 84 wt %), based on weight of the fabric care composition, of water. More preferably, the fabric care composition of the present invention, comprises 10 to 94.98 wt % (preferably, 20 to 92.4 wt %; more preferably, 35 to 89.8 wt %; most preferably, 50 to 84 wt %), based on weight of the fabric care composition, of water; wherein the water is at least one of distilled water and deionized water. Most preferably, the fabric care composition of the present invention, comprises 10 to 94.98 wt % (preferably, 20 to 92.4 wt %; more preferably, 35 to 89.8 wt %; most preferably, 50 to 84 wt %), based on weight of the fabric care composition, of water; wherein the water is distilled and deionized.

Preferably, the fabric care composition of the present invention, comprises 0.01 to 3 wt % (preferably, 0.05 to 2.5 wt %; more preferably, 0.1 to 2 wt %; most preferably, 0.5 to 1.5 wt %), based on weight of the fabric care composition, of a fragrance. More preferably, the fabric care composition of the present invention, comprises 0.01 to 3 wt % (preferably, 0.05 to 2.5 wt %; more preferably, 0.1 to 2 wt %; most preferably, 0.5 to 1.5 wt %), based on weight of the fabric care composition, of a fragrance; wherein the fragrance includes a component selected from the group consisting of benzyl alcohol, citronellol, linalool, limonene and mixtures thereof (preferably, benzyl alcohol, limonene, citronellol and mixtures thereof). Still more preferably, the fabric care composition of the present invention, comprises 0.01 to 3 wt % (preferably, 0.05 to 2.5 wt %; more preferably, 0.1 to 2 wt %; most preferably, 0.5 to 1.5 wt %), based on weight of the fabric care composition, of a fragrance; wherein the fragrance includes a component selected from the group consisting of benzyl alcohol, limonene, citronellol and mixtures thereof. Most preferably, the fabric care composition of the present invention, comprises 0.01 to 3 wt % (preferably, 0.05 to 2.5 wt %; more preferably, 0.1 to 2 wt %; most preferably, 0.5 to 1.5 wt %), based on weight of the fabric care composition, of a fragrance; wherein the fragrance includes a component selected from the group consisting of limonene, benzyl alcohol and mixtures thereof.

Preferably, the fabric care composition of the present invention, comprises 0.01 to 5 wt % (preferably, 0.05 to 4 wt %; more preferably, 0.1 to 3 wt %; most preferably, 0.5 to 2 wt %), based on weight of the fabric care composition, of a deposition aid polymer; wherein the deposition aid polymer is a cationic dextran polymer, comprising a dextran base polymer functionalized with quaternary ammonium groups; wherein the dextran base polymer has a weight average molecular weight of 50,000 to 3,000,000 Daltons; and wherein the quaternary ammonium groups include (i) a quaternary ammonium group of formula (II) bound to a pendent oxygen on the dextran base polymer; and (ii) a quaternary ammonium group of formula (III) bound to a pendent oxygen on the dextran base polymer.

Preferably, the dextran base polymer has a weight average molecular weight of 50,000 to 3,000,000 Daltons (preferably, 100,000 to 2,000,000 Daltons; more preferably, 125,000 to 1,000,000 Daltons; still more preferably, 130,000 to 650,000 Daltons; most preferably, 140,000 to 500,000 Daltons). More preferably, the dextran base polymer has a weight average molecular weight of (preferably, 100,000 to 2,000,000 Daltons; more preferably, 125,000 to 1,000,000 Daltons; still more preferably, 130,000 to 650,000 Daltons; most preferably, 140,000 to 500,000 Daltons); and the dextran base polymer is a branched chain dextran polymer comprising a plurality of glucose structural units; wherein 90 to 98 mol % (preferably, 92.5 to 97.5 mol %; more preferably, 93 to 97 mol %; most preferably, 94 to 96 mol %) of the glucose structural units are connected by α-1,6 linkages and 2 to 10 mol % (preferably, 2.5 to 7.5 mol %; more preferably, 3 to 7 mol %; most preferably, 4 to 6 mol %) of the glucose structural units are connected by α-1,2 linkages, α-1,3 linkages and/or α-1,4 linkages. Most preferably, the dextran base polymer has a weight average molecular weight of (preferably, 100,000 to 2,000,000 Daltons; more preferably, 125,000 to 1,000,000 Daltons; still more preferably, 130,000 to 650,000 Daltons; most preferably, 140,000 to 500,000 Daltons); and the dextran base polymer is a branched chain dextran polymer comprising a plurality of glucose structural units; wherein 90 to 98 mol % (preferably, 92.5 to 97.5 mol %; more preferably, 93 to 97 mol %; most preferably, 94 to 96 mol %) of the glucose structural units are connected by α-D-1,6 linkages and 2 to 10 mol % (preferably, 2.5 to 7.5 mol %; more preferably, 3 to 7 mol %; most preferably, 4 to 6 mol %) of the glucose structural units are connected by α-1,3 linkages according to formula I

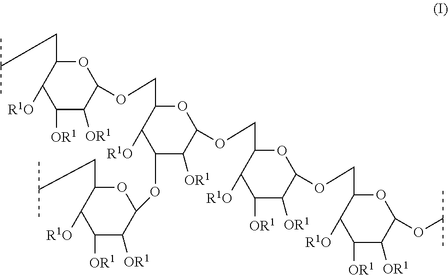

wherein R¹ is selected from a hydrogen, a C₁_₄ alkyl group and a hydroxy C₁_₄ alkyl group; and wherein the average branch off the dextran polymer backbone is 1 to 3 anhydroglucose units.

Preferably, the dextran base polymer contains less than 0.01 wt %, based on weight of the dextran base polymer, of alternan. More preferably, the dextran base polymer contains less than 0.001 wt %, based on weight of the dextran base polymer, of alternan. Most preferably, the dextran base polymer contains less than the detectable limit of alternan.

Preferably, <0.1 mol % (preferably, <0.01 mol %; more preferably, <0.001 mol %; most preferably, <detectable limit), of the glucose structural units in the dextran base polymer are connected by β-1,4 linkages.

Preferably, <0.1 mol % (preferably, <0.01 mol %; more preferably, <0.001 mol %; most preferably, <detectable limit), of the glucose structural units in the dextran base polymer are connected by β-1,3 linkages.

Preferably, the fabric care composition of the present invention, comprises 0.01 to 5 wt % (preferably, 0.05 to 4 wt %; more preferably, 0.1 to 3 wt %; most preferably, 0.5 to 2 wt %), based on weight of the fabric care composition, of a deposition aid polymer; wherein the deposition aid polymer is a cationic dextran polymer, comprising a dextran base polymer functionalized with quaternary ammonium groups; wherein the quaternary ammonium groups include (i) a quaternary ammonium group of formula (II) bound to a pendent oxygen on the dextran base polymer and (ii) a quaternary ammonium group of formula (III) bound to a pendant oxygen on the dextran base polymer

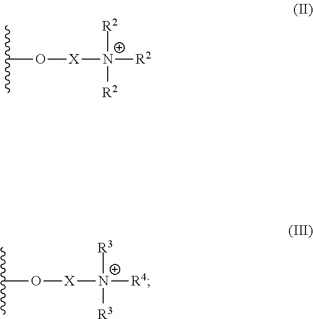

wherein

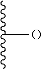 [SMILES: *O]

is a pendent oxygen on the dextran base polymer; wherein X is a divalent linking group (preferably, wherein X is selected from divalent alkyl groups, which may optionally be substituted with a hydroxy group, an alkoxy group and/or an ether group; more preferably, wherein X is a —CH₂CH(OR⁵)CH₂— group, where R⁵ is selected from the group consisting of a hydrogen and a linear or branched C₁₋₄ alkyl group; most preferably, wherein X is a —CH₂CH(OH)CH₂— group); wherein each R² is independently selected from a C₁₋₄ alkyl group (preferably, a linear or branched C₁₋₃ alkyl group; more preferably, a C₁₋₂ alkyl group; most preferably, a methyl group); wherein each R³ is independently selected from a C₁₋₄ alkyl group (preferably, a linear or branched C₁₋₃ alkyl group; more preferably, a C₁₋₂ alkyl group; most preferably, a methyl group); wherein each R⁴ is independently selected from a linear or branched C₈₋₂₀ alkyl group (preferably, a linear or branched C₁₀₋₁₆ alkyl group; more preferably, a linear or branched C₁₀₋₁₄ alkyl group; still more preferably, a linear or branched C₁₂ alkyl group; most preferably, a linear C₁₂ alkyl group); and wherein the degree of substitution, DS_{(II)}, of quaternary ammonium groups of formula (II) on the cationic dextran polymer is 0.01 to 0.245 (preferably, 0.1 to 0.2); wherein the degree of substitution, DS_{(III)}, of quaternary ammonium groups of formula (III) on the cationic dextran polymer is >0 to 0.05 (preferably, 0.003 to 0.05; more preferably, 0.005 to 0.02; most preferably, >0.007 to 0.01). More preferably, the fabric care composition of the present invention, comprises 0.01 to 5 wt % (preferably, 0.05 to 4 wt %; more preferably, 0.1 to 3 wt %; most preferably, 0.5 to 2 wt %), based on weight of the fabric care composition, of a deposition aid polymer; wherein the deposition aid polymer is a cationic dextran polymer, comprising a dextran base polymer functionalized with quaternary ammonium groups; wherein the quaternary ammonium groups include (i) a quaternary ammonium group of formula (IIa) bound to a pendent oxygen on the dextran base polymer and (ii) a quaternary ammonium group of formula (IIIa) bound to a pendant oxygen on the dextran base polymer

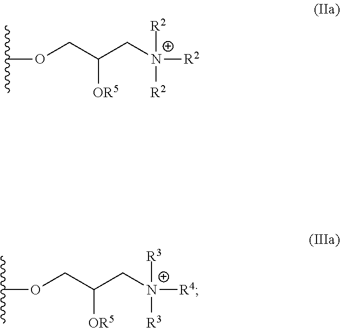

wherein

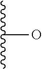 [SMILES: *O]

is a pendent oxygen on the dextran base polymer; wherein each R² is independently selected from a linear or branched C₁₋₄ alkyl group (preferably, a C₁₋₃ alkyl group; more preferably, a C₁₋₂ alkyl group; most preferably, a methyl group); wherein each R³ is independently selected from a linear or branched C₁₋₄ alkyl group (preferably, a C₁₋₃ alkyl group; more preferably, a C₁₋₂ alkyl group; most preferably, a methyl group); wherein each R⁴ is independently selected from a linear or branched C₈₋₂₀ alkyl group (preferably, a linear or branched C₁₀₋₁₆ alkyl group; more preferably, a linear or branched C₁₀₋₁₄ alkyl group; still more preferably, a linear or branched C₁₂ alkyl group; most preferably, a linear C₁₂ alkyl group); wherein each R⁵ is independently selected from the group consisting of a hydrogen and a linear or branched C₁_₄ alkyl group (preferably, a hydrogen); and wherein the degree of substitution, DS_{(II)}, of quaternary ammonium groups of formula (II) on the cationic dextran polymer is 0.01 to 0.245 (preferably, 0.1 to 0.2); wherein the degree of substitution, DS_{(III)}>, of quaternary ammonium groups of formula (III) on the cationic dextran polymer is >0 to 0.05 (preferably, 0.003 to 0.05; more preferably, 0.005 to 0.02; most preferably, >0.007 to 0.01). Most preferably, the fabric care composition of the present invention, comprises 0.01 to 5 wt % (preferably, 0.05 to 4 wt %; more preferably, 0.1 to 3 wt %; most preferably, 0.5 to 2 wt %), based on weight of the fabric care composition, of a deposition aid polymer; wherein the deposition aid polymer is a cationic dextran polymer, comprising a dextran base polymer functionalized with quaternary ammonium groups; wherein the quaternary ammonium groups include (i) a quaternary ammonium group of formula (IIa) bound to a pendent oxygen on dextran the polymer; and (ii) a quaternary ammonium group of formula (IIIa) bound to a pendent oxygen on dextran the polymer; wherein each R² is a methyl group; wherein each R³ is a methyl group; wherein each R⁴ is a linear C₁₂ alkyl group; wherein each R⁵ is a hydrogen; and wherein the degree of substitution, DS_{(II)}, of quaternary ammonium groups of formula (II) on the cationic dextran polymer is 0.01 to 0.245 (preferably, 0.1 to 0.2); wherein the degree of substitution, DS_{(III)}, of quaternary ammonium groups of formula (III) on the cationic dextran polymer is >0 to 0.05 (preferably, 0.003 to 0.05; more preferably, 0.005 to 0.02; most preferably, >0.007 to 0.01).

Preferably, the deposition aid polymer has a Kjeldahl nitrogen content, TKN, of 0.5 to 2 wt % (preferably, 0.6 to 1.7 wt %; more preferably, 0.75 to 1.6 wt %; most preferably, 0.9 to 1.5 wt %) measured using a Buchi KjelMaster K-375 automated analyzer, corrected for volatiles and ash measured as described in ASTM method D-2364.

Preferably, 70 to 98 wt % (preferably, 80 to 96 wt %; more preferably, 81 to 94 wt %; most preferably, 92 to 92 wt %) of the quaternary ammonium groups on the deposition aid polymer are quaternary ammonium groups of formula (II) (preferably, wherein the quaternary ammonium groups of formula (II) are of formula (IIa)) and 2 to 30 wt % (preferably, 4 to 20 wt %; more preferably, 6 to 19 wt %; most preferably, 8 to 15 wt %) of the quaternary ammonium groups on the deposition aid polymer are quaternary ammonium groups of formula (III) (preferably, wherein the quaternary ammonium groups of formula (III) are of formula (IIIa)).

Preferably, the deposition aid polymer contains <0.001 meg/gram (preferably, <0.0001 meq/gram; more preferably, <0.00001 meq/gram; most preferably, <detectable limit) of aldehyde functionality.

Preferably, the deposition aid polymer contains <0.001 meq/gram (preferably, <0.0001 meq/gram; more preferably, <0.00001 meq/gram; most preferably, <detectable limit) of silicone containing functionality.

Preferably, the deposition aid polymer contains <0.1 mol % (preferably, 0 to <0.01 mol %; more preferably, 0 to <0.001 mol %; most preferably, 0 to <detectable limit) of structural units of a reactive siloxane, wherein the structural units of a reactive siloxane include Si—O moieties. More preferably, the deposition aid polymer contains <0.1 mol % (preferably, 0 to <0.01 mol %; more preferably, 0 to <0.001 mol %; most preferably, 0 to <detectable limit) of structural units of a reactive siloxane, wherein the structural units of a reactive siloxane include Si—O moieties; wherein the reactive siloxane is a polymer which may comprise one or more functional moieties selected from the group consisting of amino, amido, alkoxy, hydroxy, polyether, carboxy, hydride, mercapto, sulfate phosphate, and/or quaternary ammonium moieties—these moieties may be attached directly to the siloxane backbone through a bivalent alkylene radical, (i.e., pendant) or may be part of the backbone.

Preferably, the fabric care composition of the present invention is a laundry detergent.

Preferably, the fabric care composition of the present invention is a laundry detergent. Preferably, the laundry detergent optional comprises additives selected from the group consisting of cleaning surfactants; builders (e.g., sodium citrate), hydrotropes (e.g., ethanol, propylene glycol), enzymes (e.g., protease, lipase, amylase), preservatives, perfumes (e.g., essential oils such as D-limonene), fluorescent whitening agents, dyes, additive polymers and mixtures thereof.

Preferably, the fabric care composition of the present invention, further comprises 0 to 89.9 wt % (preferably, 5 to 75 wt %; more preferably, 10 to 60 wt %; most preferably, 15 to 40 wt %), based on weight of the fabric care composition, of a cleaning surfactant. More preferably, the fabric care composition of the present invention, further comprises 0 to 89.9 wt % (preferably, 5 to 75 wt %; more preferably, 10 to 60 wt %; most preferably, 15 to 40 wt %), based on weight of the fabric care composition, of a cleaning surfactant; wherein the cleaning surfactant is selected from the group consisting of anionic surfactants, nonionic surfactants, cationic surfactants, amphoteric surfactants and mixtures thereof. Still more preferably, the fabric care composition of the present invention, further comprises 0 to 89.9 wt % (preferably, 5 to 75 wt %; more preferably, 10 to 60 wt %; most preferably, 15 to 40 wt %), based on weight of the fabric care composition, of a cleaning surfactant; wherein the cleaning surfactant is selected from the group consisting of a mixture including an anionic surfactant and a non-ionic surfactant. Most preferably, the fabric care composition of the present invention, further comprises 0 to 89.9 wt % (preferably, 5 to 75 wt %; more preferably, 10 to 60 wt %; most preferably, 15 to 40 wt %), based on weight of the fabric care composition, of a cleaning surfactant; wherein the cleaning surfactant includes a mixture of a linear alkyl benzene sulfonate, a sodium lauryl ethoxysulfate and a nonionic alcohol ethoxylate.

Anionic surfactants include alkyl sulfates, alkyl benzene sulfates, alkyl benzene sulfonic acids, alkyl benzene sulfonates, alkyl polyethoxy sulfates, alkoxylated alcohols, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenols, alkyl phenol polyethoxy ether sulfates, 2-acryloxy-alkane-1-sulfonic acid, 2-acryloxy-alkane-1-sulfonate, beta-alkyloxy alkane sulfonic acid, beta-alkyloxy alkane sulfonate, amine oxides and mixtures thereof. Preferred anionic surfactants include C₈₋₂₀ alkyl benzene sulfates, C₈₋₂₀ alkyl benzene sulfonic acid, C₈₋₂₀ alkyl benzene sulfonate, paraffin sulfonic acid, paraffin sulfonate, alpha-olefin sulfonic acid, alpha-olefin sulfonate, alkoxylated alcohols, C₈₋₂₀ alkyl phenols, amine oxides, sulfonates of fatty acids, sulfonates of fatty acid esters and mixtures thereof. More preferred anionic surfactants include C₁₂₋₁₆ alkyl benzene sulfonic acid, C₁₂₋₁₆ alkyl benzene sulfonate, C₁₂₋₁₈ paraffin-sulfonic acid, C₁₂₋₁₈ paraffin-sulfonate and mixtures thereof.

Nonionic surfactants include secondary alcohol ethoxylates, ethoxylated 2-ethylhexanol, ethoxylated seed oils, butanol caped ethoxylated 2-ethylhexanol and mixtures thereof. Preferred non-ionic surfactants include secondary alcohol ethoxylates.

Cationic surfactants include quaternary surface active compounds. Preferred cationic surfactants include quaternary surface active compounds having at least one of an ammonium group, a sulfonium group, a phosphonium group, an iodinium group and an arsonium group. More preferred cationic surfactants include at least one of a dialkyldimethylammonium chloride and alkyl dimethyl benzyl ammonium chloride. Still more preferred cationic surfactants include at least one of C₁₆₋₁₈ dialkyldimethylammonium chloride, a C₈₋₁₈ alkyl dimethyl benzyl ammonium chloride di-tallow dimethyl ammonium chloride and di-tallow dimethyl ammonium chloride. Most preferred cationic surfactant includes di-tallow dimethyl ammonium chloride.

Amphoteric surfactants include betaines, amine oxides, alkylamidoalkylamines, alkyl-substituted amine oxides, acylated amino acids, derivatives of aliphatic quaternary ammonium compounds and mixtures thereof. Preferred amphoteric surfactants include derivatives of aliphatic quaternary ammonium compounds. More preferred amphoteric surfactants include derivatives of aliphatic quaternary ammonium compounds with a long chain group having 8 to 18 carbon atoms. Still more preferred amphoteric surfactants include at least one of C₁₂₋₁₄ alkyldimethylamine oxide, 3-(N,N-dimethyl-N-hexadecyl-ammonio)propane-1-sulfonate, 3-(N,N-dimethyl-N-hexadecylammonio)-2-hydroxypropane-1-sulfonate. Most preferred amphoteric surfactants include at least one of C₁₂₋₁₄ alkyldimethylamine oxide.

Preferably, the fabric care composition of the present invention further comprises: 0 to 30 wt % (preferably, 0.1 to 15 wt %; more preferably, 1 to 10 wt %), based on the weight of the fabric care composition, of a builder. More preferably, the fabric care composition of the present invention further comprises: 0 to 30 wt % (preferably, 0.1 to 15 wt %; more preferably, 1 to 10 wt %), based on the weight of the fabric care composition, of a builder; wherein the builder is selected from the group consisting of inorganic builders (e.g., tripolyphosphate, pyrophosphate); alkali metal carbonates; borates; bicarbonates; hydroxides; zeolites; citrates (e.g., sodium citrate); polycarboxylates; monocarboxylates; aminotrismethylenephosphonic acid; salts of aminotrismethylenephosphonic acid; hydroxyethanediphosphonic acid; salts of hydroxyethanediphosphonic acid; diethylenetriaminepenta(methylenephosphonic acid); salts of diethylenetriaminepenta(methylenephosphonic acid); ethylenediaminetetraethylene-phosphonic acid; salts of ethylenediaminetetraethylene-phosphonic acid; oligomeric phosphonates; polymeric phosphonates; mixtures thereof. Most preferably, the fabric care composition of the present invention further comprises: 0 to 30 wt % (preferably, 0.1 to 15 wt %; more preferably, 1 to 10 wt %), based on the weight of the fabric care composition, of a builder; wherein the builder includes a citrate (preferably, a sodium citrate).

Preferably, the fabric care composition of the present invention further comprises: 0 to 10 wt % (preferably, 1 to 10 wt %; more preferably, 2 to 8 wt %; most preferably, 5 to 7.5 wt %), based on the weight of the fabric care composition, of a hydrotrope. More preferably, the fabric care composition of the present invention further comprises: 0 to 10 wt % (preferably, 1 to 10 wt %; more preferably, 2 to 8 wt %; most preferably, 5 to 7.5 wt %), based on the weight of the fabric care composition, of a hydrotrope; wherein the hydrotrope is selected from the group consisting of alkyl hydroxides; glycols, urea; monoethanolamine; diethanolamine; triethanolamine; calcium, sodium, potassium, ammonium and alkanol ammonium salts of xylene sulfonic acid, toluene sulfonic acid, ethylbenzene sulfonic acid and cumene sulfonic acid; salts thereof and mixtures thereof. Still more preferably, the fabric care composition of the present invention further comprises: 0 to 10 wt % (preferably, 1 to 10 wt %; more preferably, 2 to 8 wt %; most preferably, 5 to 7.5 wt %), based on the weight of the fabric care composition, of a hydrotrope; wherein the hydrotrope is selected from the group consisting of ethanol, propylene glycol, sodium toluene sulfonate, potassium toluene sulfonate, sodium xylene sulfonate, ammonium xylene sulfonate, potassium xylene sulfonate, calcium xylene sulfonate, sodium cumene sulfonate, ammonium cumene sulfonate and mixtures thereof. Yet still more preferably, the fabric care composition of the present invention further comprises: 0 to 10 wt % (preferably, 1 to 10 wt %; more preferably, 2 to 8 wt %; most preferably, 5 to 7.5 wt %), based on the weight of the fabric care composition, of a hydrotrope; wherein the hydrotrope includes at least one of ethanol, propylene glycol and sodium xylene sulfonate. Most preferably, the fabric care composition of the present invention further comprises: 0 to 10 wt % (preferably, 1 to 10 wt %; more preferably, 2 to 8 wt %; most preferably, 5 to 7.5 wt %), based on the weight of the fabric care composition, of a hydrotrope; wherein the hydrotrope is a mixture of ethanol, propylene glycol and sodium xylene sulfonate.

Preferably, the fabric care composition is in a liquid form having a pH from 6 to 12.5; preferably at least 6.5, preferably at least 7, preferably at least 7.5; preferably no greater than 12.25, preferably no greater than 12, preferably no greater than 11.5. Suitable bases to adjust the pH of the formulation include mineral bases such as sodium hydroxide (including soda ash) and potassium hydroxide; sodium bicarbonate, sodium silicate, ammonium hydroxide; and organic bases such as mono-, di- or tri-ethanolamine; or 2-dimethylamino-2-methyl-1-propanol (DMAMP). Mixtures of bases may be used. Suitable acids to adjust the pH of the aqueous medium include mineral acid such as hydrochloric acid, phosphorus acid, and sulfuric acid; and organic acids such as acetic acid. Mixtures of acids may be used. The formulation may be adjusted to a higher pH with base and then back titrated to the ranges described above with acid.

Preferably, the fabric care composition of the present invention, contains less than 0.05 wt % (preferably, <0.01 wt %; more preferably, <0.001 wt %; most preferably, less than the detectable limit), based on weight of the fabric care composition, of a fabric softening silicone.

The present invention provides a method of treating an article of laundry, comprising: providing an article of laundry; providing a fabric care composition of the present invention; providing a bath water; and applying the bath water and the fabric care composition to the article of laundry (preferably, wherein the article of laundry is a fabric selected from the group consisting of cotton interlock, cotton, poly cotton blend and cotton terry; more preferably, wherein the fabric contains cotton; most preferably, wherein the fabric is cotton) to provide a treated article of laundry; wherein the fragrance included in the fabric care composition is associated with the treated article of laundry (preferably, wherein the fragrance is not covalently bonded to the treated article of laundry). More preferably, the present invention provides a method of treating an article of laundry, comprising: providing an article of laundry (preferably, wherein the article of laundry is a fabric selected from the group consisting of cotton interlock, cotton, poly cotton blend and cotton terry; more preferably, wherein the fabric contains cotton; most preferably, wherein the fabric is cotton); providing a fabric care composition of the present invention; providing a bath water; and applying the bath water and the fabric care composition to the article of laundry to provide a treated article of laundry; wherein the fragrance included in the fabric care composition is associated with the treated article of laundry (preferably, wherein the fragrance is not covalently bonded to the treated article of laundry) and wherein the deposition aid polymer enhances deposition of the fragrance from the fabric care composition onto a fabric relative to an otherwise identical formulation without the deposition aid polymer.

Some embodiments of the present invention will now be described in detail in the following Examples.

### Synthesis S1: Synthesis of Cationic Dextran Polymer

A 500 mL, four necked, round bottom flask fitted with a rubber serum cap, a nitrogen inlet, a pressure equalizing addition funnel, a stirring paddle and motor, a subsurface thermocouple connected to a J-KEM controller and a Friedrich condenser connected to a mineral oil bubbler was charged with dextran polymer (25 g; Sigma-Aldrich product D4876) and deionized water (100 g). The weight average molecular weight of the dextran polymer was 100,000 to 200,000 Daltons. The addition funnel was charged with a 70% aqueous solution of 2,3-epoxypropyltrimethylammonium chloride (30 g; QUAB® 151 available from SKW QUAB Chemicals) and a 40% aqueous solution of 3-chloro-2-hydroxypropyl-lauryl-dimethylammonium chloride (39.3 g; QUAB® 342 available from SKW QUAB Chemicals). While the flask contents were stirring, the apparatus was purged with nitrogen to displace any oxygen entrained in the system for one hour. The nitrogen flow rate was about 1 bubble per second.

Using a plastic syringe, a 25% aqueous sodium hydroxide solution (11 g) was added over a period of a couple minutes to the flask contents with stirring under nitrogen. The flask contents were then allowed to stir under nitrogen for one hour. The contents of the addition funnel were then charged to the flask contents dropwise over a few minutes under nitrogen with continued stirring. After the contents of the addition funnel were transferred to the flask contents, the mixture was allowed to stir for 20 minutes. Then heat was applied to the flask contents with a heating mantle controlled using the J-KEM controller set at 55° C. The flask contents were heated to and maintained at 55° C. for 1.5 hours.

The flask contents were then cooled in an ice water bath while maintaining a positive nitrogen pressure in the flask. When the flask contents reached room temperature, glacial acetic acid (1.66 g) was added to the flask contents. The flask contents were then stirred for 10 minutes under nitrogen. The product solution was used without further purification. The product polymer was characterized by nuclear magnetic resonance (1H NMR) spectroscopy for structural analysis to determine the degree of substitution, DS_{(II)}, of trimethyl ammonium moieties and, DS_{(III)}, of dimethyldodecyl ammonium moieties reported in TABLE 2.

### Syntheses S2-S4: Synthesis of Cationic Dextran Polymer

In Syntheses S2-S4, cationic dextran polymers were prepared substantially as described in Synthesis S1 but with varying reagent feeds as noted in TABLE 1. The degree of substitution, DS_{(II)}, of the QUAB® 151 and, DS_{(III)}, of the QUAB® 342 in the product cationic dextran polymers measured by 1H NMR is reported in TABLE 2. The calculated total Kjeldahl nitrogen, TKN, in the product cationic dextran polymers based on the DS values is also reported in TABLE 2.

### Synthesis S5: Synthesis of Cationic Dextran Polymer

A one ounce vial was charged with dextran polymer (3 g; Sigma-Aldrich product D4876) and deionized water (7 g). A stir bar was added to the vial and the vial was capped. The vial was then placed on a stir plate and heated to 55° C. After the dextran was completely dissolved, a 25% aqueous sodium hydroxide solution (0.6 g) was added to the vial contents. The vial contents continued to stir for 10 minutes at 55° C. before adding to the vial contents a 40% aqueous solution of 3-chloro-2-hydroxypropyl-lauryl-dimethylammonium chloride (0.1607 g; QUAB® 342 available from SKW QUAB Chemicals). The vial contents were then stirred for 30 minutes before adding to the vial contents a 70% aqueous solution of 2,3-epoxypropyltrimethylammonium chloride (1.6 g; QUAB® 151 available from SKW QUAB Chemicals). The vial contents were then stirred for 60 minutes at 55° C. The vial contents were then cooled to room temperature. When the vial contents reached room temperature, glacial acetic acid (0.19 g) was added to the vial contents. The vial contents were then stirred for 10 minutes. The product solution was used without further purification. The product polymer was characterized by 1H NMR for structural analysis to determine the degree of substitution, DS_{(II)}, of trimethyl ammonium moieties and, DS_{(III)}, of dimethyldodecyl ammonium moieties reported in TABLE 2.

### Synthesis S6: Synthesis of Cationic Dextran Polymer

In Synthesis S6, a cationic dextran polymer was prepared substantially as described in Synthesis S5 but with varying reagent feeds as noted in TABLE 1. The degree of substitution, DS_{(II)}, of the QUAB® 151 and, DS_{(III)}, of the QUAB® 342 in the product cationic dextran polymer measured by 1H NMR is reported in TABLE 2. The calculated total Kjeldahl nitrogen, TKN, in the product cationic dextran polymer based on the DS values is also reported in TABLE 2.

### Synthesis S7: Synthesis of Cationic Dextran Polymer

A one ounce vial was charged with dextran polymer (2.5 g; Sigma-Aldrich product D4876) and deionized water (6 g). A stir bar was added to the vial and the vial was capped. The vial was then placed on a stir plate and heated to 55° C. After the dextran was completely dissolved, a 25% aqueous sodium hydroxide solution (0.7 g) was added to the vial contents. The vial contents continued to stir for 10 minutes at 55° C. before adding to the vial contents a 40% aqueous solution of 3-chloro-2-hydroxypropyl-lauryl-dimethylammonium chloride (3 g; QUAB® 342 available from SKW QUAB Chemicals) and a 70% aqueous solution of 2,3-epoxypropyltrimethylammonium chloride (1.1 g; QUAB® 151 available from SKW QUAB Chemicals). The vial contents were then stirred for 60 minutes at 55° C. The vial contents were then cooled to room temperature. When the vial contents reached room temperature, glacial acetic acid (0.19 g) was added to the vial contents. The vial contents were then stirred for 10 minutes. The product solution was used without further purification. The product polymer was characterized by 1H NMR for structural analysis to determine the degree of substitution, DS_{(II)}, of trimethyl ammonium moieties and, DS_{(III)}, of dimethyldodecyl ammonium moieties reported in TABLE 2.

### Synthesis S8-S9: Synthesis of Cationic Dextran Polymer

In Syntheses S8-S9, a cationic dextran polymer was prepared substantially as described in Synthesis S7 but with varying reagent feeds as noted in TABLE 1. The degree of substitution, DS_{(II)}, of the QUAB® 151 and, DS_{(III)}, of the QUAB® 342 in the product cationic dextran polymer measured by 1H NMR is reported in TABLE 2. The calculated total Kjeldahl nitrogen, TKN, in the product cationic dextran polymer based on the DS values is also reported in TABLE 2.

TABLE 1

| | Dextran | Water | NaOH | QUAB ® | QUAB ® |
|---|---|---|---|---|---|
| Ex. | (g) | (g) | (g) | 151 (g) | 342 (g) |
| S1 | 25.0 | 100.0 | 11.0 | 30.0 | 39.3 |
| S2 | 25.0 | 102.7 | 7.5 | 30.1 | 19.7 |
| S3 | 25.1 | 102.3 | 5.6 | 30.0 | 9.9 |
| S4 | 40.2 | 89.6 | 6.4 | 20.9 | 0 |
| S5 | 3.0 | 7.0 | 0.6 | 1.6 | 0.2 |
| S6 | 3.0 | 5.3 | 1.0 | 1.6 | 2.4 |
| S7 | 2.5 | 6.0 | 0.7 | 3.0 | 1.1 |
| S8 | 3.0 | 5.7 | 0.6 | 5.6 | 0.2 |
| S9 | 2.0 | 6.2 | 0.7 | 1.1 | 1.6 |

TABLE 2

| | Trimethyl | Dimethyl dodecyl | |
|---|---|---|---|
| | ammonium, | ammonium, | |
| Ex. | DS_{(II)} | DS_{(III)} | TKN |
| S1 | 0.121 | 0.013 | 1.018 |
| S2 | 0.191 | 0.008 | 1.440 |
| S3 | 0.164 | 0.007 | 1.267 |
| S4 | 0.21 | 0 | 1.751 |
| S5 | 0.091 | 0.003 | 0.745 |
| S6 | 0.071 | 0.033 | 0.796 |
| S7 | 0.152 | 0.029 | 1.307 |
| S8 | 0.241 | 0.002 | 1.708 |
| S9 | 0.011 | 0.068 | 0.599 |

### Synthesis S10: Fragrance

A fragrance solution was prepared having the composition noted in TABLE 3.

TABLE 3

| | Compontent (wt %) | | | |
|---|---|---|---|---|
| Synthesis S10 | Benzyl alcohol | Citronellol | Linalool | Limonene |
| Fragrance | 25 | 25 | 25 | 25 |
| solution | | | | |

### Comparative Examples CF1-CF6 and Examples F1-F4: Fabric Care Composition

Fabric care compositions were prepared in each of Comparative Examples CF1-CF6 and Examples F1-F4 having the formulation as described in TABLE 4 and prepared by standard laundry formulation preparation procedure. The fabric care compositions were observed for formulation stability, with those exhibiting a phase separation being identified as not stable. The results of these observations are reported in TABLE 4.

TABLE 4

| | CF1 | CF2 | CF3 | CF4 | CF5 | CF6 | F1 | F2 | F3 | F4 |
|---|---|---|---|---|---|---|---|---|---|---|
| Ingredient | wt % | | | | | | | | | |
| LAS¹ | 8.0 | 8.0 | 8.0 | 8.0 | 8.0 | 8.0 | 8.0 | 8.0 | 8.0 | 8.0 |
| SLES² | 6.0 | 6.0 | 6.0 | 6.0 | 6.0 | 6.0 | 6.0 | 6.0 | 6.0 | 6.0 |
| Propylene glycol | 5.0 | 5.0 | 5.0 | 5.0 | 5.0 | 5.0 | 5.0 | 5.0 | 5.0 | 5.0 |
| Ethanol | 2.0 | 2.0 | 2.0 | 2.0 | 2.0 | 2.0 | 2.0 | 2.0 | 2.0 | 2.0 |
| Nonionic surfactant³ | 6.0 | 6.0 | 6.0 | 6.0 | 6.0 | 6.0 | 6.0 | 6.0 | 6.0 | 6.0 |
| Sodium citrate | 5.0 | 5.0 | 5.0 | 5.0 | 5.0 | 5.0 | 5.0 | 5.0 | 5.0 | 5.0 |
| Example S1 (active) | — | — | — | — | — | — | 2 | — | — | — |
| Example S2 (active) | — | — | — | — | — | — | — | 2 | — | — |
| Example S3 (active) | — | — | — | — | — | — | — | — | 2 | — |
| Example S4 (active) | — | 2 | — | — | — | — | — | — | — | — |
| Example S5 (active) | — | — | — | — | — | — | — | — | — | 2 |
| Example S6 (active) | — | — | 2 | — | — | — | — | — | — | — |
| Example S7 (active) | — | — | — | 2 | — | — | — | — | — | — |
| Example S8 (active) | — | — | — | — | 2 | — | — | — | — | — |
| Example S9 (active) | — | — | — | — | — | 2 | — | — | — | — |
| Example S10 | 1 | 1 | 1 | 1 | 1 | 1 | 1 | 1 | 1 | 1 |
| NaOH | Adjust pH to 8.0 | | | | | | | | | |
| Deionized water | q.s. 100 | | | | | | | | | |
| Stable Formulation? | yes | yes | no | no | no | no | yes | yes | yes | yes |

¹Nacconol 90G linear alkyl benzene sulfonate available from Stepan Company
²Steol CS-460 sodium lauryl ethoxysulfate available from Stepan Company
³Biosoft N25-7 nonionic alcohol ethoxylate available from Stepan Company

### Fragrance In-Wash Deposition

Fragrance deposition from washing solutions containing the fabric care compositions was evaluated with five replicates for each of the compositions of Comparative Examples CF1-CF2 and Examples F1-F3 on cotton test swatches (Scientific Services S/D Inc. Cotton 400). The cotton test swatches were cut into 0.5 inch diameter cotton disks. The initial dry mass of each cotton disk was measured and recorded. A separate 25 mL vial was provided for each of the fabric care compositions tested. Water (20 mL of 200 ppm (3:1 Ca²⁺:Mg²⁺ by weight)) was then added to each vial. A magnetic stirrer and a fabric care composition (0.4 g) was then added to each of the vials. The vials were then placed on a stir plate set at 1,000 rpm. A cotton disk was then added to each vial and left to stir for 16 minutes. The wash solution was then drained from each vial and fresh water (20 mL of 200 ppm (3:1 Ca²⁺:Mg²⁺ by weight) was then added to each vial with the cotton disk and stir bar. The vials were then placed back on the stir plate set at 1,000 rpm and left to stir 3 minutes. The cotton disks were then recovered from the vials and placed on a drying rack for 60 minutes. Each dried disk was then placed into a separate 20 mL gas chromatography (GC) headspace vial and crimp sealed immediately. The final mass of each cotton disk was then measured and recorded.

### Gas Chromatography/Mass Spectrometry Analysis

The mass of fragrance deposited onto the fabric using each of the fragrance containing fabric care compositions of Comparative Examples CF1-CF2 and Examples F1-F3 was quantified by gas chromatography/mass spectrometry (GC-MS) using an Agilent 7890B GC with 5977 MS detector and an Agilent 7697A headspace sampler with the settings noted in TABLES 5 and 6. Standards of the four fragrances (benzyl alcohol, citronellol, linalool, and limonene) were prepared in hexanes by weight (ranging in concentration from 10-1000 ppm, wt/wt). The standards were prepared for headspace GC-MS analysis by weighing 10-15 mg of each calibration mix into 22 mL headspace vials and capping with Teflon-lined septa. The headspace analysis of the standards was done in a full-evaporation mode to eliminate matrix effects that can occur in static headspace sampling. In this mode, a small sample size is used, and the headspace vial temperature is set sufficiently high to allow for full evaporation of the volatile of interest. A calibration plot was prepared for each individual fragrance using at least five standard concentrations for that compound. The mg amount of each fragrance in each sample was then determined using the linear-least-squares equation from the calibration plot for that compound. The mg amount detected in each piece of fabric was then converted to ng of fragrance. The average mass of fragrance components (in ng) detected on the surface of the test fabrics for the five replicates is reported in TABLE 7.

TABLE 5
GC-MS Parameters

| | |
|---|---|
| Column: | DB-Wax UI: 30 m × 0.25 mm × 0.5 μm |
| | Model number: Agilent 122-7033UI |
| | Mode: Constant pressure |
| | Nominal initial pressure: 11.853 psi |
| | Average velocity: 43.122 cm/second |
| | Gas type: Helium |
| Inlet | Mode: Split |
| | Temperature: 240° C. |
| | Pressure: 11.853 psi |
| | Split ratio: 10:1 |
| | Split flow: 14 mL/minute |
| | Total flow: 18.4 mL/minute |
| Oven program | Initial temperature: 50° C., hold for 2 minutes |
| | Temperature ramp: 20° C./minute |
| | Final temperature: 230° C, hold for 8 minutes |
| | Total run time: 19 minutes |
| Mass detector | Acquisition mode: SIM |
| | Number of ions: 8 (m/z 41, 43, 68, 69, 71, 79, 93, 108) |
| | Total dwell time: 400 ms (50 ms/ion) |
| | Solvent delay: 5 minutes |
| | Resulting EM voltage: 1044.131 |
| | Quad/source temps: 150° C./230° C. |

TABLE 6
Headspace Autosampler Parameters

| | |
|---|---|
| Oven temperature: | 200° C. |
| Loop temperature: | 220° C. |
| Transfer line temperature: | 230° C. |
| Vial equilibrium time: | 10 or 30 minutes |
| Loop size: | 1 mL |
| Fill pressure: | 15 psi |
| Pressurization time | 2.0 minutes |
| Injection time: | 0.2 minutes |
| GC cycle time: | 27 or 57 minutes |

TABLE 7

| Fabric care | Fragrance component (ng) | | | |
|---|---|---|---|---|
| composition | Limonene | Linalool | Citronellol | Benzyl alcohol |
| Comp. Ex. CF1 | 1.0 (±0.03) | 0 | 2.1 (±0.07) | 6.9 (±0.25) |
| Comp. Ex. CF2 | 1.1 (±0.12) | 0 | 11.2 (±2.50) | 6.7 (±0.39) |
| Example F2 | 4.9 (±0.30) | 0 | 2.7 (±0.46) | 15.6 (±1.44) |
| Example F3 | 6.1 (±0.39) | 0 | 29.3 (±5.06) | 46.2 (±14.47) |
| Example F4 | 4.8 (±0.53) | 0 | 4.5 (±0.95) | 17.6 (±0.92) |

### Soil Anti-Redeposition (Prophetic)

The soil anti-redeposition of the fabric care compositions is evaluated for each of the compositions of Comparative Example CF2 and Example F1 on four types of fabric (cotton interlock, cotton, polyester/cotton blend, cotton terry) by washing the fabrics in a Terg-O-tometer under typical washing conditions (ambient wash temperature, water hardness: 200 ppm Ca²⁺:Mg²⁺ of 3:1 mole ratio, with a 60 minute wash and a 3 minute rinse, 1 L/wash) using a detergent dosage of 0.5 g/L. An orange (high iron content) clay slurry (0.63 g Red Art Clay) and dust sebum dispersion (2.5 g) is the added soil load. Once washing is complete, the fabric swatches are dried, and read on a Mach5 color instrument to compute the Whiteness Index (WI) in accordance with ASTM E313. The results provided as delta Whiteness Index (ΔWI E313), with lower values being better; indicate that Example F1 outperforms the soil anti-redeposition performance of Comparative Example CF2.

We claim:

1. A fabric care composition, comprising:
water;
a fragrance; and
a deposition aid polymer, wherein the deposition aid polymer is a cationic dextran polymer, comprising a dextran base polymer functionalized with quaternary ammonium groups; wherein the dextran base polymer has a weight average molecular weight of 50,000 to 3,000,000 Daltons; wherein the quaternary ammonium groups include
(i) a quaternary ammonium group of formula (II) bound to a pendent oxygen on the dextran base polymer 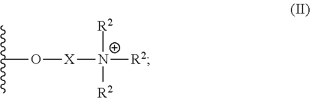
and
(ii) a quaternary ammonium group of formula (III) bound to a pendent oxygen on the dextran base polymer 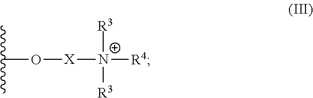
wherein 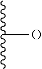 [SMILES: *O]
is a pendent oxygen on the dextran base polymer; wherein X is a divalent linking group; wherein each R² is independently selected from a C₁₋₄ alkyl group; wherein each R³ is independently selected from a C₁₋₄ alkyl group; and wherein each R⁴ is independently selected from a linear or branched C₈₋₂₀ alkyl group; wherein the degree of substitution, DS_{(II)}, of quaternary ammonium groups of formula (II) on the cationic dextran polymer is 0.01 to 0.245; wherein the degree of substitution, DS_{(III)}, of quaternary ammonium groups of formula (III) on the cationic dextran polymer is >0 to 0.05; wherein the degree of substitution, DS_{(III)}, of quaternary ammonium groups of formula (III) on the cationic dextran polymer is >0 to 0.05; and
wherein the deposition aid polymer enhances deposition of the fragrance from the fabric care composition onto a fabric relative to an otherwise identical formulation without the deposition aid polymer.

2. The fabric care composition of claim 1, wherein the fabric care composition contains less than 0.05 wt %, based on weight of the fabric care composition, of a fabric softening silicone.

3. The fabric care composition of claim 1, wherein the deposition aid polymer has a Kjeldahl nitrogen content corrected for ash and volatiles of 0.5 to 2.0 wt %.

4. The fabric care composition of claim 3, wherein the dextran base polymer is a branched chain dextran polymer functionalized with quaternary ammonium groups.

5. The fabric care composition of claim 4, wherein the branched chain dextran polymer comprises a plurality of glucose structural units; wherein 90 to 98 mol % of the glucose structural units are connected by α-1,6 linkages and 2 to 10 mol % of the glucose structural units are connected by α-1,3 linkages.

6. The fabric care composition of claim 5, further comprising a cleaning surfactant; wherein the fabric care composition is an aqueous laundry detergent formulation.

7. The aqueous laundry detergent formulation of claim 6, wherein the cleaning surfactant is selected from the group consisting of anionic surfactants, nonionic surfactants, cationic surfactants, amphoteric surfactants and mixtures thereof.

8. The aqueous laundry detergent formulation of claim 7, wherein the cleaning surfactant includes a mixture of a linear alkyl benzene sulfonate, a sodium lauryl ethoxysulfate and a nonionic alcohol ethoxylate.

9. A method of treating an article of laundry, comprising: providing an article of laundry; selecting a fabric care composition according to claim 1; providing a bath water; and applying the bath water and the fabric care composition to the article of laundry to provide a treated article of laundry; wherein the fragrance is associated with the treated article of laundry.

10. The method of claim 9, wherein the fabric care composition is an aqueous laundry detergent formulation according to claim 8.
